(19) United States
(12) Patent Application Publication
(10) Pub. No.: US 2004/0082226 A1
(43) Pub. Date: Apr. 29, 2004

(54) Electrical socket outlet

(76) Inventors: Siegfried Schulte, Ludenscheid (DE); Manfred Aulmann, Schalksmuhle (DE)

Correspondence Address: EDWIN D. SCHINDLER, Five Hirsch Avenue, P. O. Box 966, Coram, NY, 11727-0966, US

(21) Appl. No.: 10/689,203

(22) Filed: Oct. 20, 2003

(30) Foreign Application Priority Data
Oct. 23, 2002 (DE) 202 16 369.5

(51) Int. Cl. H01R 39/00

(52) U.S. Cl. 439/638

(57) ABSTRACT

Electrical socket outlet having two rectangular plug-in openings, whose broad sides are aligned parallel to one another, and having a grounding opening lying on the center perpendicular of the line connecting the plug-in openings, the socket outlet comprising a plug-in shell and a bottom shell, wherein slots in the plug-in shell accommodate essentially straight contact rails and a likewise essentially straight grounding rail, each having a U-shaped cross section, wherein the free ends of the limbs of the contact rails and the grounding rail point toward the plug-in openings and the grounding opening, and wherein the limbs of the contact rails and the grounding rail are supported on both sides of the slots by transverse webs.

### 1. FIELD OF THE INVENTION

The invention relates to an electrical socket outlet having two rectangular plug-in openings, whose broad sides are aligned parallel to one another, and having a grounding opening lying on the center perpendicular of the line connecting the plug-in openings, the socket outlet comprising a plug-in shell and a bottom shell.

### 2. DESCRIPTION OF THE PRIOR ART

The socket outlet can be pushed and/or latched into a profile system of installation equipment such as a cable duct, a table duct, a connection column or the like.

In a plug system of the type described, the distance between the plug pins and between said plug pins and the grounding pin is small, which causes complications when forming and arranging the contact rails or the grounding rail in a multiple socket outlet.

### 3. SUMMARY OF THE INVENTION

The object of the invention is for the contact rails and the grounding rail to have as simple a construction as possible whilst ensuring sufficient contact force.

This object is achieved according to the invention by slots in the plug-in shell accommodating essentially straight contact rails and a likewise essentially straight grounding rail, each having a U-shaped cross section, by the free ends of the limbs of the contact rails and the grounding rail pointing toward the plug-in openings and the grounding opening, and by the limbs of the contact rails and the grounding rail being supported on both sides of the slots by transverse webs.

The invention is distinguished from the prior art in that the straight contact rails and the straight grounding rail can be produced in a simple manner by stamping and bending to form a U-shaped profile. The U-shaped rails provide direct contact without the need for additional contact elements or contact tubes. The limbs of the contact rails are supported on transverse webs of the slot walls in order thus to increase the flexibility of the limbs and to ensure a high and uniform contact force.

In order to increase the flexibility of the limbs in the contact region and to improve the contact, it is proposed that the contact rails and the grounding rail each have in their base cutouts which are aligned with the plug-in openings and the grounding opening, respectively.

In order to adapt the flexibility of the limbs to the plug-in openings and the grounding opening, the transverse webs are provided in the region of the plug-in openings and the grounding opening.

The contact rails and the grounding rail are supported in the opposite direction to the plug-in direction by the lower shell comprising a rectangular bottom plate having transverse walls whose profiled projections support and align the contact rails and the grounding rail.

In order to install the socket outlet in a profile system, provision is made for guides, matching accommodating profiles of a profile system which accommodates the socket outlet, to be formed on the side walls of the upper shell.

In order that the contact rails and the grounding rail can be used directly for connection to further socket outlets, provision is made for the contact rails and the grounding rail each to end in the longitudinal direction on one side in a holder in the form of a gripper for connecting further socket outlets.

Reliable contact is ensured during connection to a further socket outlet or to a power supply socket outlet by the contact rails and the grounding rail each ending in the longitudinal direction on the other side in a plug tongue in the form of a web for connection to a holder in the form of a gripper or to a contact tube of a power supply socket outlet.

The plug tongue in the form of a web is made to fit various internal dimensions of the holders or contact tubes by it having transverse corrugations for increasing the effective thickness.

### 4. BRIEF DESCRIPTION OF THE DRAWINGS

An exemplary embodiment is explained with reference to the drawings, in which:

FIG. 1 shows an overall view of the socket outlet having a power supply socket outlet,

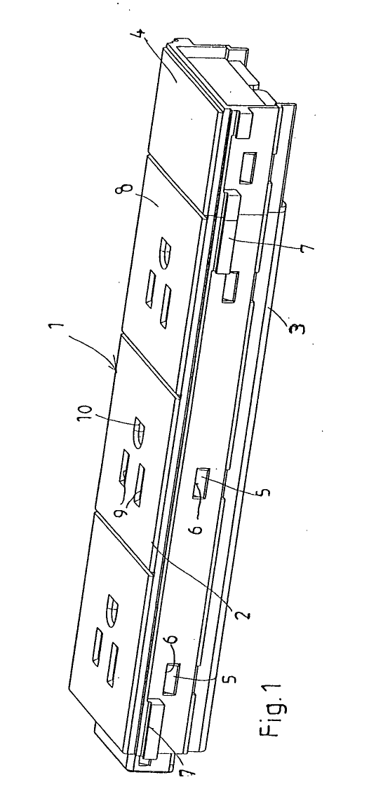

FIG. 2 shows an exploded illustration of the socket outlet shown in FIG. 1 from above,

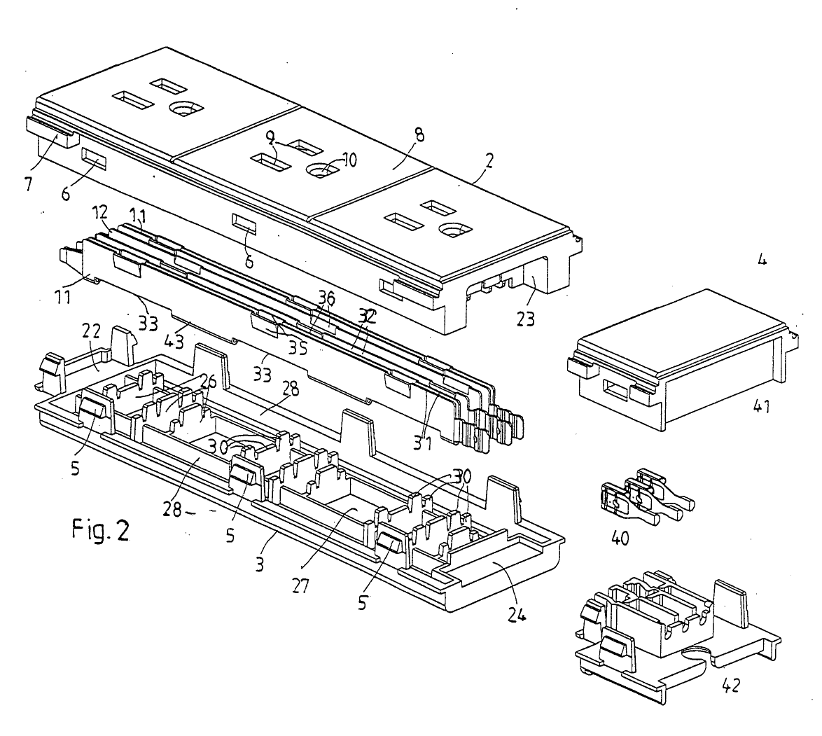

FIG. 3 shows a corresponding exploded illustration from below, and

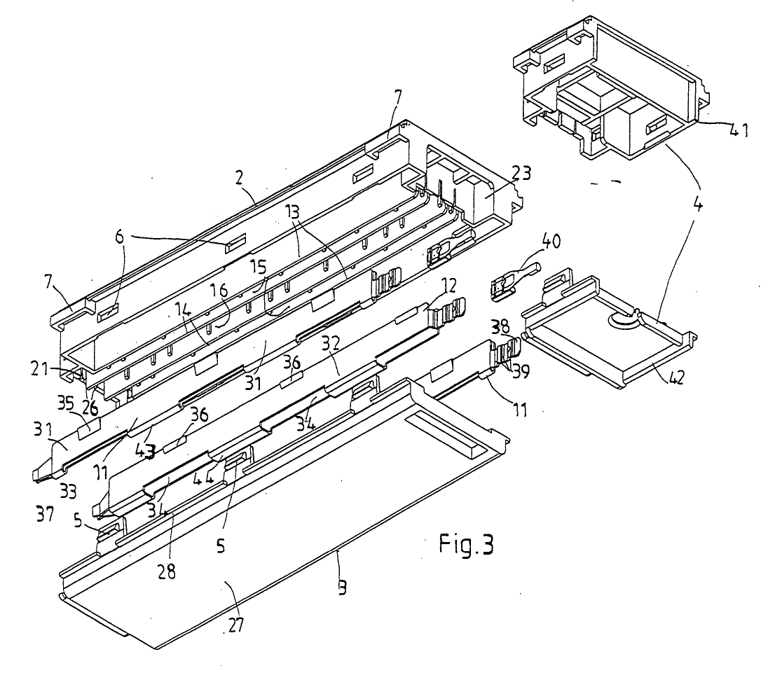

FIG. 4 shows a view from below of the plug-in shell of the socket outlet.

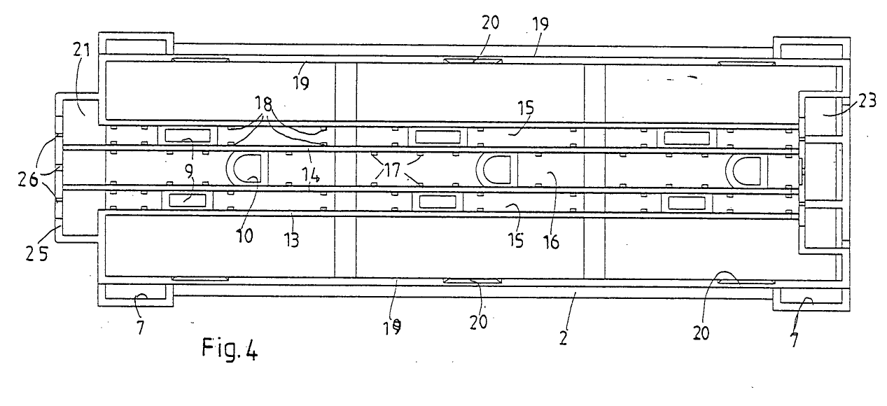

### 5. DESCRIPTION OF THE PREFERRED EMBODIMENT

The figures show a multiple socket outlet for installation in a profile system of connection columns, wall ducts, floor ducts, table ducts or the like.

The socket outlet 1 is in the form of a triple socket outlet and comprises a plug-in shell 2 and a lower shell 3. The socket outlet 1 can be connected to a power supply socket outlet 4.

The plug-in shell 2 and the lower shell 3 have an essentially rectangular contour. Latching lugs 5 on the lower shell 3 engage in receptacles 6 in the plug-in shell 2. This makes it possible to connect and to latch the plug-in shell 3 and the upper shell 2 to one another. Guides 7 are designed such that they match the accommodating profiles of a profile system (not shown) which accommodates the socket outlet 1.

The plug-in shell 2 has a rectangular top wall 8 having three plug-in configurations. Each plug-in configuration comprises two rectangular plug-in openings 9, with their broad sides aligned parallel to one another, and a grounding opening 10, lying on the center perpendicular of the line connecting the plug-in openings 9, for a corresponding plug system. These plug-in openings 9 and the grounding opening 10 are close to one another in the transverse direction of the socket outlet 1 so that it is difficult for sufficient insulating gaps to be formed and maintained for contact rails 11 and a grounding rail 12. Four longitudinal walls 13 and 14 are therefore formed in the longitudinal direction of the plug-in shell 2 and thus, in each case in pairs, delimit three slots 15 and 16, the narrower slots 15 each accommodating a contact rail 11, and the wider slot 16 accommodating the grounding rail 12.

The surfaces delimiting the slot 16, of the longitudinal walls 14 bear transverse webs 17 for aligning and supporting the grounding rail 12, as will be explained in more detail below; The surfaces of the longitudinal walls 14 and the surfaces of the longitudinal walls 13, which delimit the slots 15, likewise bear transverse webs 18 for aligning and supporting the contact rails 11. The abovementioned receptacles 6 are formed in the side walls 19. Aligned with these receptacles 6, the side walls 19 have guide profiles 20 for the latching lugs 5 of the lower shell 3.

Formed in the plug-in shell 2 and the lower shell 3, on the transverse sides of said plug-in shell 2 and said lower shell 3 of the socket outlet 1 are, on one side, a connecting chamber 21, 22 and, on the other side, a terminal chamber 23, 24. The connecting chamber 21, 22 has plug-in slots 26 in the end wall 25 for contact rails of an adjacent socket outlet. The terminal chamber 23, 24 is in the form of a pot and accommodates the ends of the contact rails 11 and the grounding rail 12. The plug part of the power supply socket outlet 4 can be inserted into the terminal chamber 23, 24, as will be explained in more detail further below.

The lower shell 3 comprises a rectangular bottom plate 27 having side walls 28 and having transverse walls 29, whose profiled projections 30 support and align the contact rails 11 and the grounding rail 12. The abovementioned latching lugs 5, which engage in the receptacles 6 in the plug-in shell 2, are also positioned on the bottom plate 27.

The contact rails 11 and the grounding rail 12 are essentially straight rails having a U-shaped cross section, each having bases 43, 44 and limbs 31, 32. Cutouts 33, 34, which are aligned with the plug-in openings 9 and the grounding opening 10, are in each case formed in the base 43, 44. In the region of these cutouts 33, 34, the limbs 31 and 32, respectively, have increased flexibility such that the contact plugs and the grounding pin of the plug part (not shown) are retained with sufficient contact force. The limbs 31 of the contact rails 11 have cut-away tabs. 35, by means of which in each case a tapering insertion duct is formed for a flat plug pin. Corresponding tabs 36 are formed on the limbs 32 of the grounding rail 12. The distance of the limbs 31 of the contact rails 11 from one another is smaller than the distance between the limbs 32 of the grounding rail 12. The contact rails 11 and the grounding rail 12 are thus stamped and bent parts which are simple to produce. Contact elements or the like which have been additionally welded on are not required.

The power supply socket outlet 4 likewise comprises an upper shell 41 and a lower shell 42 which can be latched to one another. Contact tubes 40 are inserted into chambers of this upper shell 41 and lower shell 42. The plug tongue 38 in each case fills up the internal cross section of the contact tube 40 by means of transverse corrugations 39 and can be made to fit various internal cross sections of contact tubes.

We claim the following:

1. An electrical socket outlet having two rectangular plug-in openings, whose broad sides are aligned parallel to one another, and having a grounding opening lying on the center perpendicular of the line connecting the plug-in openings, the socket outlet comprising a plug-in shell and a bottom shell, wherein slots in the plug-in shell accommodate essentially straight contact rails and a likewise essentially straight grounding rail, each having a U-shaped cross section, wherein the free ends of the limbs of the contact rails and the grounding rail point toward the plug-in openings and the grounding opening, and wherein the limbs of the contact rails and the grounding rail are supported on both sides of the slots by transverse webs.

2. The electrical socket outlet as claimed in claim 1, wherein the contact rails and the grounding rail each have in their base cutouts which are aligned with the plug-in openings or with the grounding opening.

3. The electrical socket outlet as claimed in claim 1, wherein the transverse webs are provided in the region of the plug-in openings and the grounding opening.

4. The electrical socket outlet as claimed in claim 3, wherein the lower shell comprises a rectangular bottom plate having transverse walls whose profiled projections support and align the contact rails and the grounding rail.

5. The electrical socket outlet as claimed in claim 4, wherein guides, matching accommodating profiles of a profile system which accommodates the socket outlet, are formed on the side walls of the upper shell.

6. The electrical socket outlet as claimed in claim 5, wherein the contact rails and the grounding rail each end in the longitudinal direction on one side in a holder in the form of a gripper for connecting further socket outlets.

7. The electrical socket outlet as claimed in claim 6, wherein the contact rails and the grounding rail each end in the longitudinal direction on the other side in a plug tongue in the form of a web for connection to a holder in the form of a gripper or to a contact tube of a power supply socket outlet.

8. The electrical socket outlet as claimed in claim 7, wherein the plug tongue in the form of a web has transverse corrugations for increasing the effective thickness.
